(19) United States
(12) Patent Application Publication
(10) Pub. No.: US 2026/0367872 A1
(43) Pub. Date: Nov. 19, 2026

(54) MULTI-AGENT SOFTWARE DEVELOPMENT LIFECYCLE SYSTEM

(71) Applicant: TRETE Inc., Prosper, TX (US)

(72) Inventors: Damien Patton, Plano, TX (US); Christian Gratton, Eaton Rapids, MI (US); Rish Mehta, Castro Valley, CA (US)

(21) Appl. No.: 19/632,133

(22) Filed: Mar. 27, 2026

Related U.S. Application Data
(60) Provisional application No. 63/778,588, filed on Mar. 27, 2025.

(51) Int. Cl. G06F 8/10

(52) U.S. Cl. CPC G06F 8/10

(57) ABSTRACT

A multi-agent software development system comprising an orchestrator configured to classify incoming work requests and route them through workflow lanes based on classification. The system includes variant zone agents comprising a ticket agent configured to normalize raw requests into structured ticket artifacts, a ticket review agent configured to validate ticket readiness, a CTO agent configured to define architectural constraints and implementation boundaries, an execution design agent configured to convert architectural guidance into execution-ready plans, and a TDD agent configured to define test-first correctness expectations. The system includes shared zone agents comprising an integration agent, a refactor agent, a PR readiness agent, a code review agent, a security agent, and a documentation agent.

### CROSS REFERENCE TO RELATED APPLICATIONS

The present application claims the benefit of priority under 35 U.S.C. §119 from United States Provisional Patent Application Serial No. 63/778,588, entitled “Methods and Systems for an Optimized Software Development Lifecycle,” filed on Mar. 27, 2025, all of which is incorporated herein by reference in its entirety for all purposes.

### FIELD OF INVENTION

The present disclosure relates to software development methodologies and systems, and more particularly to automated software development lifecycle that integrates specialized multi-agent frameworks arranged in a deterministic, multi-lane processing architecture.

### BACKGROUND

Modern software engineering organizations face significant challenges in maintaining consistent quality, security, and architectural coherence across diverse work types including new feature development, bug remediation, multi-feature project initiatives, and production incident response. Conventional project management and workflow tools provide tracking capabilities but fail to enforce deterministic execution standards, architectural constraints, or quality invariants across the full engineering lifecycle.

Existing approaches to AI-assisted software development typically employ monolithic AI systems that lack the specialization necessary to handle fundamentally different work types (e.g., new feature architecture versus production incident triage) while simultaneously maintaining consistent downstream quality standards. Such systems cannot guarantee that a code review for a bug fix applies the same rigor as a code review for a new feature, nor can they enforce that specific architectural invariants are never violated regardless of work type or urgency.

Furthermore, prior art fails to provide a unified system that (a) diverges work through specialized planning agents calibrated to specific work types while (b) converging all work through identical shared validation agents, thereby guaranteeing uniform quality standards without sacrificing work-type-specific planning intelligence. There remains a need for an integrated system that enforces human accountability at precisely defined checkpoints, provides deterministic and auditable routing decisions, and prevents architectural drift across all categories of engineering work.

### SUMMARY

The present invention provides an orchestrator-driven agentic engineering system utilizing a deterministic state machine. According to one aspect of the present disclosure, a multi-agent software development system is provided. The multi-agent software development system includes an agent configured to analyze project specifications and generate architectural recommendations. The multi-agent software development system includes a planning agent configured to receive the architectural recommendations and generate a project plan. The multi-agent software development system includes a test agent configured to analyze the project plan and determine testing requirements. The multi-agent software development system includes a decomposition agent configured to receive the project plan and the testing requirements and generate tickets representing discrete work units. The multi-agent software development system includes a coding agent configured to receive the tickets and generate code implementing functionality specified in each ticket. The coding agent is configured to produce pull requests containing no more than 300 lines of code per pull request. The multi-agent software development system includes a refactoring agent configured to receive code from the coding agent and optimize the code to reduce technical debt. The multi-agent software development system includes documentation agents configured to generate documentation for software application.

In one embodiment, the system comprises: (a) an Orchestrator Decision Engine that performs deterministic intake classification, lane routing, stage inclusion/exclusion control, state management, and invariant enforcement; (b) a Variant Agent Zone comprising lane-specific agent variants for intake normalization, architectural review, execution planning, and test-design; (c) a Shared Agent Zone comprising lane-agnostic agents for integration verification, code refactoring, PR preparation, code review, security review, and documentation; (d) an External Implementation Interface governing the boundary between the agent-controlled workflow and external coding tools; (e) a Human Gate Validation System enforcing typed human approval checkpoints; and (f) an Audit and Traceability System providing complete provenance from work item intake through deployment.

A key aspect of the invention is the architectural principle that work diverges during planning—where lane-specific agent variants apply specialized intelligence—and converges during execution and validation—where shared agents apply identical quality, security, and review standards regardless of work origin.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 depicts a system-level block diagram illustrating an exemplary architecture of an orchestrator-driven multi-agent software development lifecycle system 100 wherein the present invention may be implemented.

FIG. 2 depicts an example high level block diagram of the Orchestrator Decision Engine, according to one embodiment of the present invention.

FIG. 3 depicts an example flow diagram for Feature Lane, according to one embodiment of the present invention..

FIG. 4 depicts an example flow diagram of is a flow diagram illustrating the Bug Lane 504 workflow, showing conditional stage inclusion based on risk-level signals and the decision nodes for execution design and human pre-approval.

FIG. 5 is a flow diagram illustrating the Project/Epic Lane 506 workflow, showing project-level decomposition into child features that each execute through the Feature Lane 502.

FIG. 6 is a flow diagram illustrating the Hotfix/Incident Lane 508 workflow, showing the optimized sequence with deploy-before-documentation ordering and post-incident review governance.

FIG. 7 is a diagram illustrating the Variant Zone 200 and Shared Zone 300 boundary architecture, showing the divergence-convergence principle wherein work diverges during planning and converges during execution.

FIG. 8 is a state transition diagram of the core State Machine 110, showing all states from INTAKE through DEPLOYED, including conditional states and failure transitions.

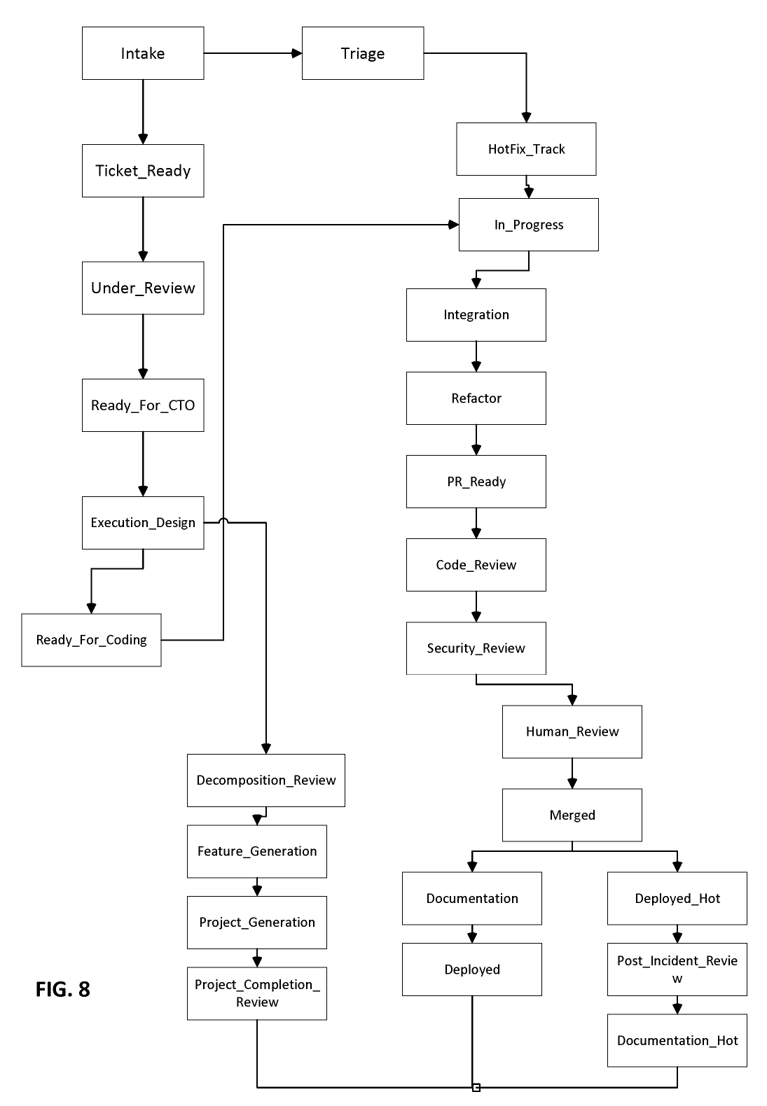

FIG. 9 is a decision tree diagram of the Intake Classification Engine 106, showing the deterministic rules for classifying incoming work as FEATURE, BUG, PROJECT, or AMBIGUOUS.

FIG. 10 is a block diagram of the Human Gate Validation System 600, showing the six typed gate categories and their lane applicability matrix.

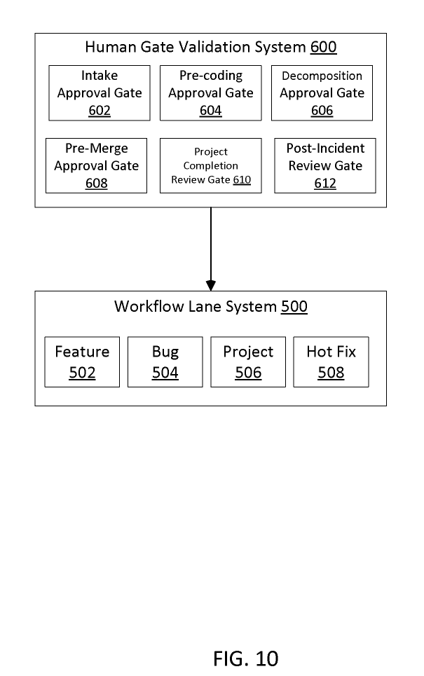

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

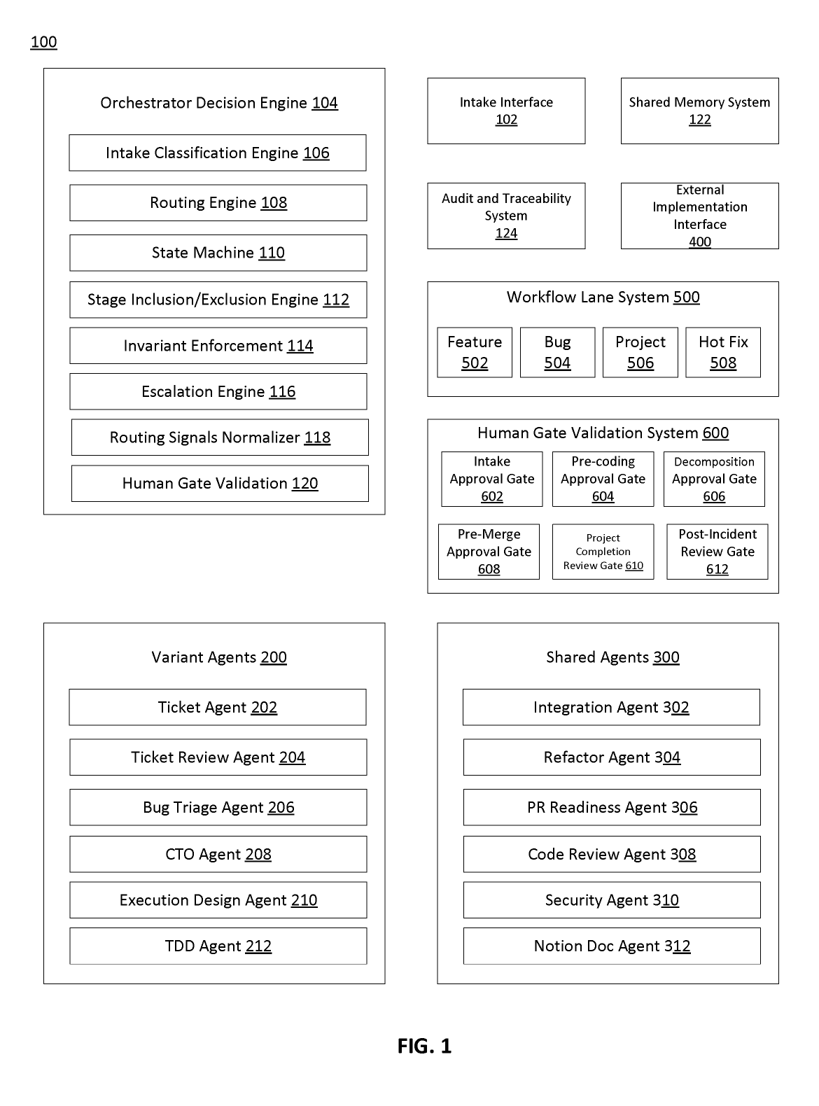

Referring now to FIG. 1, multi-agent software development lifecycle system 100 wherein the present invention may be implemented, is illustrated. As depicted, system 100 may include Intake Interface 102, Orchestrator Decision Engine 104, Variant Agents 200, Shared Agents 300, External Implementation Interface 400, Shared Memory 122, and Audit and Traceability System 124. Intake Interface 102 may receive raw engineering work requests from external sources including human input, project management tools, error monitoring systems, and communication platforms. Incoming requests are routed to the Orchestrator Decision Engine 104, which serves as the central deterministic control unit of the system.

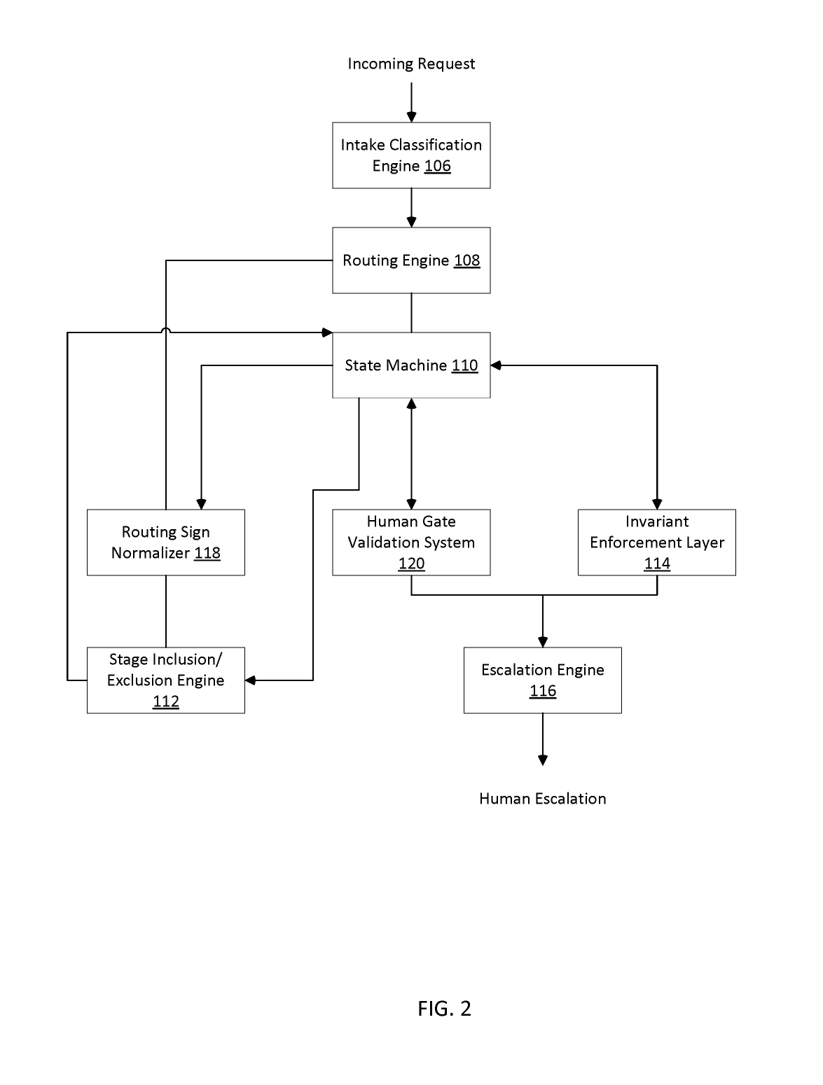

Orchestrator Decision Engine 104 governs processing through deterministic, rule-based decisions that are explainable and reproducible. Orchestrator Decision Engine 104 includes Intake Classification Engine 106, Routing Engine 108, State Machine 110, Stage Inclusion/Exclusion Engine 112, Invariant Enforcement Layer 114, Escalation Engine 116, and Routing Signals Normalizer 118. Orchestrator Decision Engine 104 communicates bidirectionally with the Variant Agents 200 and the Shared Agents 300, invoking agents in a controlled sequence determined by the current workflow lane and stage. Orchestrator Decision Engine 104 will be described in further detail in FIG. 2 below.

Variant Agents 200 may include Ticket Agent 202, Ticket Review Agent 204, Bug Triage Agent 206, Chief Technology Officer (CTO) Agent 208, Execution Design Agent 210, and Test-Driven Design (TDD) Agent 212. Ticket Agent 202 transforms raw, unstructured non-bug requests into high-quality execution-oriented draft tickets by normalizing stakeholder language into business and system outcomes. Orchestrator Decision Engine 104 invokes Ticket Agent 202 and utilizes Shared Memory 122 for historical context. Structured artifacts generated by Ticket Agent 202 are passed to Ticket Review Agent 204 for formal quality validation.

Ticket Review Agent 204 intakes features and projects and evaluates draft tickets for downstream architectural planning. Ticket Review Agent 204 validates structural completeness, problem clarity and the quality of acceptance criteria while identifying ambiguity flags, dependency gaps, and material risks. Ticket Review Agent 204 accesses Shared Memory 122 to calibrate review depth based on complexity signals.

Bug Triage Agent 206 manages software bug work, including normalizing incoming evidence and producing a structured triage package to determine the issue type, severity, and risk level. Incoming evidence may include system of record work inputs (e.g., ticket summaries, reporter notes), evidence inputs (e.g., Sentry logs, stack traces, screenshots), and historical records identifying similar prior bugs. The historical records may be stored in Shared Memory 122 and used to improve root-cause classification. Bug Triage Agent 206 evaluates whether a report represents a real bug, a high-priority incident, or an insufficiently specified issue, subsequently identifying likely affected systems and sensitive surfaces. Orchestrator Decision Engine 104 invokes and routes Bug Triage Agent 206.

CTO Agent 208 evaluates proposed technical approaches and defines formal constraints that downstream agents follow. Depending on the work type, CTO agent may execute a different specialized variant (e.g., Feature, Bug, Project, Incident) to determine if a solution is architecturally sound, identify risks, and establish “non-negotiable” implementation boundaries. Orchestrator Decision Engine 104 selects variates and routes outputs from Ticket Agent 202, and Bug Triage Agent 206, in addition to contextual inputs such as service maps, repo context, and architectural rules. Shared Memory 122 may be accessed to identify proven patterns from prior similar work and applies a proportionality rule to calibrate the depth of the architectural review based on complexity.

Execution Design Agent 210 converts approved architectural guidance into a structured, execution-ready implementation plan that defines how work should be bounded, sequenced and validated by downstream agents. Depending on the work type EDA 210 may execute a different specialized variant (e.g., Feature, Bug Fix, and Project) to translate high-level strategy into implementation phases, define interface contracts, and identify execution risks. Orchestrator Decision Engine 104 invokes EDA 210 and may reference Shared Memory 122 to reuse proven sequencing patterns or avoid historical implementation pitfalls. EDA 210 may output a comprehensive execution design package that may be reviewed by a user before implementation stage.

Test-driven Design (TDD) Agent 212 evaluates engineering work and converts approved feature scope or bug evidence into a bounded, implementation-driving definition of correctness before any code is written. TDD 212 translates architectural constraints, interface expectations, and acceptance criteria into testable behavioral expectations, relevant validation coverage (e.g., unit, integration, and contract), and invariants that do not regress. Orchestrator Decision Engine 104 executes

External Implementation Interface 400 mediates the boundary between the governed agent workflow and external code generation tools, enforcing contractual input and output requirements.

Shared Memory System 122 provides persistent context accessible to agents (e.g., Variant Agent 200 and Shared Agent 300), enabling historical pattern recognition, duplicate detection, and consistency with prior decisions.

Audit and Traceability System 124 maintains an immutable log of every classification decision, state transition, agent invocation, human gate clearance, and escalation event, providing complete provenance from intake through deployment.

Referring now to FIG. 2, the Orchestrator Decision Engine 104 comprises seven cooperating subsystems. The Intake Classification Engine 106 receives incoming requests and applies deterministic classification rules. It evaluates raw user input, attached artifacts (logs, stack traces, screenshots), system metadata (source identifiers from monitoring and project management tools), keyword detection patterns, and structural analysis to produce a work type classification of FEATURE, BUG, PROJECT, or AMBIGUOUS. When classification confidence is insufficient or conflicting signals are detected, the classification is set to AMBIGUOUS and the Escalation Engine 116 halts processing for human classification.

The Routing Engine 108 receives the work type classification and selects the appropriate workflow lane from the Workflow Lane System 500 and the initial entry agent. For BUG classifications, the Routing Engine 108 additionally consumes post-triage routing signals from the Bug Triage Agent 206 to select between the Bug Lane 504 fast path, full path, Hotfix Lane 508, or escalation. The Routing Engine 108 includes a Routing Validation Rule that detects inconsistencies between the routing recommendation and supporting signals (risk level, hotfix candidacy, issue type classification), requiring human review before proceeding when conflicts are detected.

The State Machine 110 implements a finite state automaton that tracks each work item through a defined sequence of processing states. Core states include: INTAKE, TRIAGE, TICKET_READY, UNDER_REVIEW, READY_FOR_CTO, EXECUTION_DESIGN, READY_FOR_CODING, IN_PROGRESS, INTEGRATION, REFACTOR, PR_READY, CODE_REVIEW, SECURITY_REVIEW, HUMAN_REVIEW, APPROVED, MERGED, DOCUMENTATION, and DEPLOYED. Project-specific states additionally include DECOMPOSITION_REVIEW, FEATURE_GENERATION, PROJECT_INTEGRATION, and PROJECT_COMPLETION_REVIEW. The Hotfix Lane 508 adds the POST_INCIDENT_REVIEW state between DEPLOYED and DOCUMENTATION.

The Stage Inclusion/Exclusion Engine 112 applies deterministic rules to determine which agents are invoked or skipped for each work item based on its lane, risk signals, and routing context. For example, the Execution Design Agent 210 is always included for Feature and Project lanes, conditionally included for Bug lane based on the requires_execution_design signal, and architecturally prohibited for the Hotfix Lane 508. The Refactor Agent 304 is included when the diff complexity score exceeds a configurable threshold, excluded for Hotfix lane work, and conditionally included on resubmission when maintainability flags are set.

The Invariant Enforcement Layer 114 evaluates a set of architectural invariant assertions before every state transition. These invariants include lane boundary invariants (e.g., Hotfix work must never include Execution Design; Project work must never reach the READY_FOR_CODING state), intake boundary invariants (e.g., Ticket Agent output must never contain bug classification; Bug Triage Agent is the only entry point for bug and hotfix classification), sequencing invariants (e.g., non-Hotfix work must complete documentation before deployment; Hotfix work must deploy before post-incident review), and agent boundary invariants (e.g., no agent may perform work assigned to another agent's scope; shared-zone agents must not exhibit lane-specific behavioral divergence). Any invariant violation causes immediate execution halt and escalation.

The Routing Signals Normalizer 118 aggregates and normalizes routing signals emitted by agents across the system into a consistent signal object. Different agent families use different status enumerations; the normalizer maps these to a unified set of orchestrator transition signals: STAGE_COMPLETE, STAGE_COMPLETE_WITH_CONSTRAINTS, NEEDS_REVISION, and BLOCKED. Signal sources include the Bug Triage Agent 206 (risk level, routing recommendation, execution design requirement, human pre-approval requirement, sensitive surface flags), the Code Review Agent 308 (maintainability flag, sensitive changes flag), the PR Readiness Agent 306 (documentation impact, contract changes), the Security Agent 310 (security block signal), and the orchestrator's own pre-processing (diff complexity score, services affected, files changed).

The Escalation Engine 116 manages three categories of failure: NEEDS_REVISION (soft failure—agent output valid but incomplete; returned for rework with a maximum of three retries), BLOCKED (hard failure—missing inputs or conflicting signals; halt and escalate to human), and ESCALATED (policy failure—invariant violation or missing gate record; halt, log violation, and escalate). All escalations include structured metadata: the issue, the reason, and a recommended action.

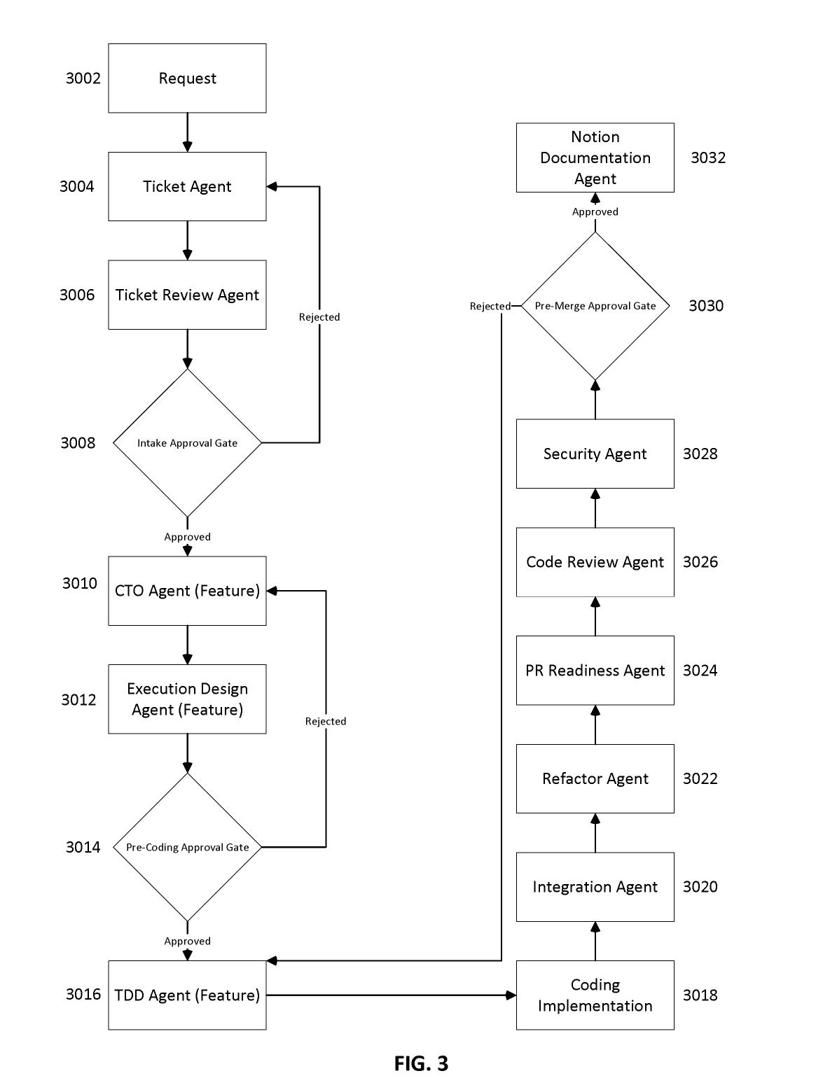

Referring now to FIG. 3, method 300 illustrates an exemplary process for the Feature Lane. The Feature Lane 502 processes new features, enhancements, and scoped product work through a complete sequence of variant agents, human gates, external implementation, and shared agents. Feature Lane 502 ensures that feature work receives appropriate planning, architectural review, and quality validation before deployment.

Method 300 begins with a raw input request (Act 302). Orchestrator Decision Engine 104 may receive raw input comprising a feature request, enhancement request, design request, or other non-bug engineering work. Intake Classification Engine 106 evaluates keyword signals, attached artifacts, and structure to classify the work. In one implementation, if the raw input contains bug signals such as logs, stack traces, error messages, or “not working” language, the request is routed to the Bug Lane. If the raw input contains project signals such as “initiative”, “roadmap”, or multi-feature scope, the request is routed to the Project Lane. If the classification is feature, Orchestrator Decision Engine 104 invokes Ticket Agent in standard mode. If the raw input contains ambiguous or conflicting signals, Orchestrator Decision Engine 104 stops and escalates to a user for classification.

Method 300 includes invoking a Ticket Agent (Act 304). In one implementation, Orchestration Decision Engine 104 may invoke Ticket Agent 202. Ticket Agent 202 normalizes the raw request and transforms raw, unstructured requests into structured draft tickets conforming to a ticket schema. Ticket Agent 202 acts as an intake normalizer and quality front door for the workflow. Ticket Agent 202 may operate in two modes: Intake Conversation Mode where Ticket Agent 202 asks up to three focused questions to fill gaps where the request is incomplete, and an Output Mode where Ticket Agent 202 produces the structured ticket draft once sufficient signal exists.

Ticket Agent 202 may receive as inputs the raw feature request, meeting notes, messages from messaging platforms (e.g., Slack) or email summaries, product context, links to documents or source materials, prior related tickets, approved historical examples, and guardrails including the engineering constitution and company policies.

Ticket Agent 202 may produce a structured ticket artifact with fields including title, ticket type, problem statement, scope, out of scope, acceptance criteria, dependencies, risks, and complexity signal. The output may also include a status of pass or needs revision, and any escalations with issue, reason, and recommended action.

Ticket Agent 202 may operate under appropriate constraints. For instance, Ticket Agent 202 may not produce a bug-classified ticket as bugs are routed to the Bug Triage Agent 206. Similarly, Ticket Agent 202 may not invent requirements not supported by source material. Further, Ticket Agent 202 may not resolve ambiguity by guessing but instead surfaces ambiguity in open questions.

Method 300 includes invoking Ticket Review Agent 204 (Act 306). Orchestrator Decision Engine 104 may invoke Ticket Review Agent 204. Ticket Review Agent 204 reviews drafted tickets and determines whether it is ready for downstream planning. Ticket Review Agent 204 may validate ticket quality and readiness by examining structural completeness, problem clarity, business context, scope boundaries, acceptance criteria quality, dependency capture, risk visibility, and classification quality.

Ticket Review Agent 204 may produce as output a ticket-review artifact with readiness status of: ready, needs revision, or blocked; review confidence of: high, medium or low; and fields for strength, missing fields, ambiguity flags, risk flags, and required revisions. The readiness status determines the next step, if ready, the ticket may proceed to the user intake approval gate for forwarding to the CTO Agent 208. If the readiness status needs revision, the ticket returns to the Ticket Agent 202 for rework with a maximum of three retries. If the readiness status is blocked, the core problem is unclear or contradictory, and the workflow escalates to the user.

Method 300 includes identifying an Intake Approval Gate has been successfully cleared (Act 308). A required user Intake Approval Gate 602 must be cleared before the CTO Agent 208 Feature Variant performs architectural review.

Method 300 includes invoking CTO Agent 208 (Act 310). Orchestrator Decision Engine 104 invokes CTO Agent 208 to evaluate whether the feature should be build as proposed. CTO Agent 208 defines architectural constraints, approved designs, implementation boundaries, and design decisions that downstream agents follow. CTO Agent 208 may evaluate ownership and service boundaries API and contract design, dependency and integration impact, scalability, sensitive surfaces, and scope integrity.

Method 300 includes invoking Execution Design Agent 210 (Act 312). Orchestrator Decision Engine 104 invokes Execution Design Agent 210 to convert the approved feature and CTO architectural guidance into an execution-ready implementation plan. Execution Design Agent 210 defines feature-level execution structure, implementation sequencing, interface expectations, dependency handling, and validation constraints for TDD Agent 212. Execution Design Agent 210 Feature Variant produces an execution-ready implementation plan.

Method 300 includes a second user Pre-Coding Approval Gate 604 that must be cleared before the TDD Agent 212 defines test-first correctness criteria (Act 314). The user may validate that the architectural approach and execution plan are sound before committing engineering time. If approved, method 300 proceeds to the TDD Agent for first-test design. If rejected, method 300 returns to the Execution Design Agent 210 for revision.

The External Implementation Interface 400 governs the coding phase. The work then converges into the Shared Agent Zone 300, proceeding through the Integration Agent 302, conditionally the Refactor Agent 304, the PR Readiness Agent 306, Code Review Agent 308, conditionally the Security Agent 310, a third required human Pre-Merge Approval Gate 608, and finally the Notion Documentation Agent 312 before deployment. In the Feature Lane 502, documentation is completed before deployment per sequencing invariant.

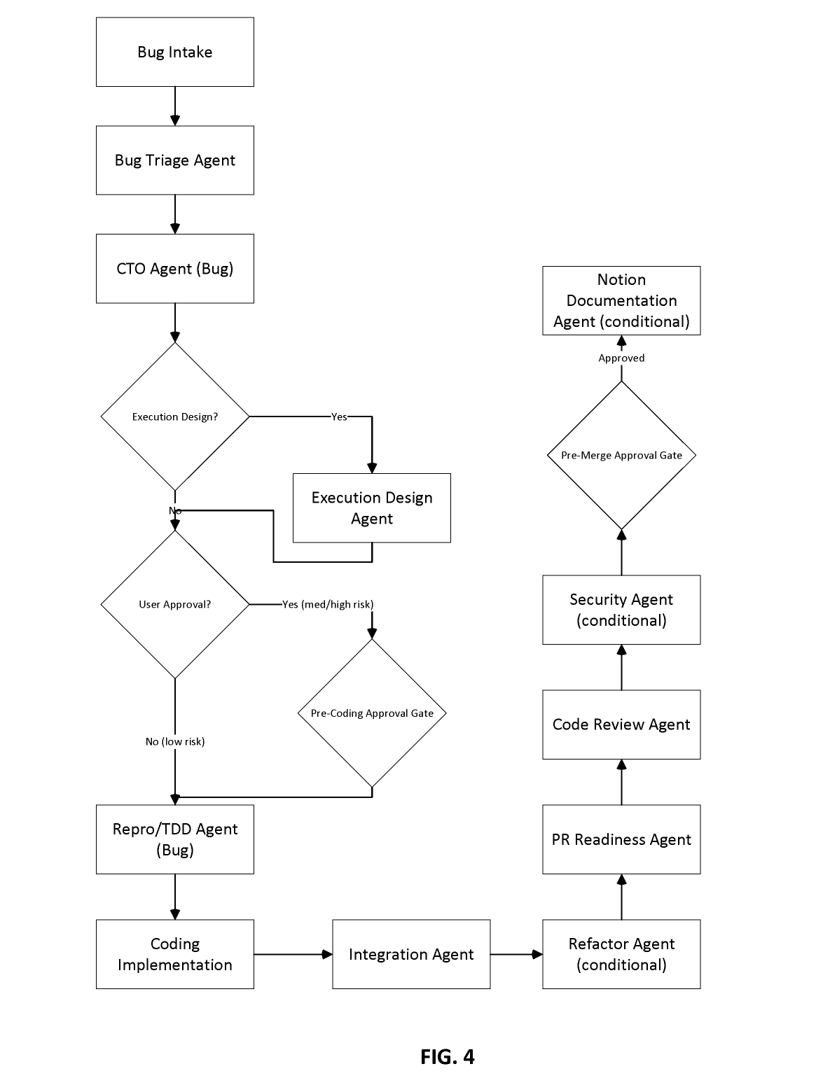

Referring now to FIG. 4, the Bug Lane 504 begins at the Bug Triage Agent 206, bypassing the Ticket Agent 202 and Ticket Review Agent 204. The Bug Triage Agent 206 produces classification, severity, risk, and routing signals that drive two critical decision nodes. The first decision node evaluates requires_execution_design: when true (risk is high, multiple services involved, or sensitive surfaces touched), the Execution Design Agent 210 Bug Fix Variant is invoked; when false (bounded, low-risk, localized repair), execution design is skipped. The second decision node evaluates requires_human_pre_approval: when true (medium or high risk, sensitive surfaces, or ambiguous fix strategy), the human Pre-Coding Approval Gate 604 is invoked as an optional gate; when false (clearly bounded low-risk bug), the gate is skipped. Both decision signals originate exclusively from the Bug Triage Agent 206. From the Repro/TDD Agent 214 Bug Variant onward, the work converges into the Shared Agent Zone 300 using identical agents and standards as the Feature Lane 502.

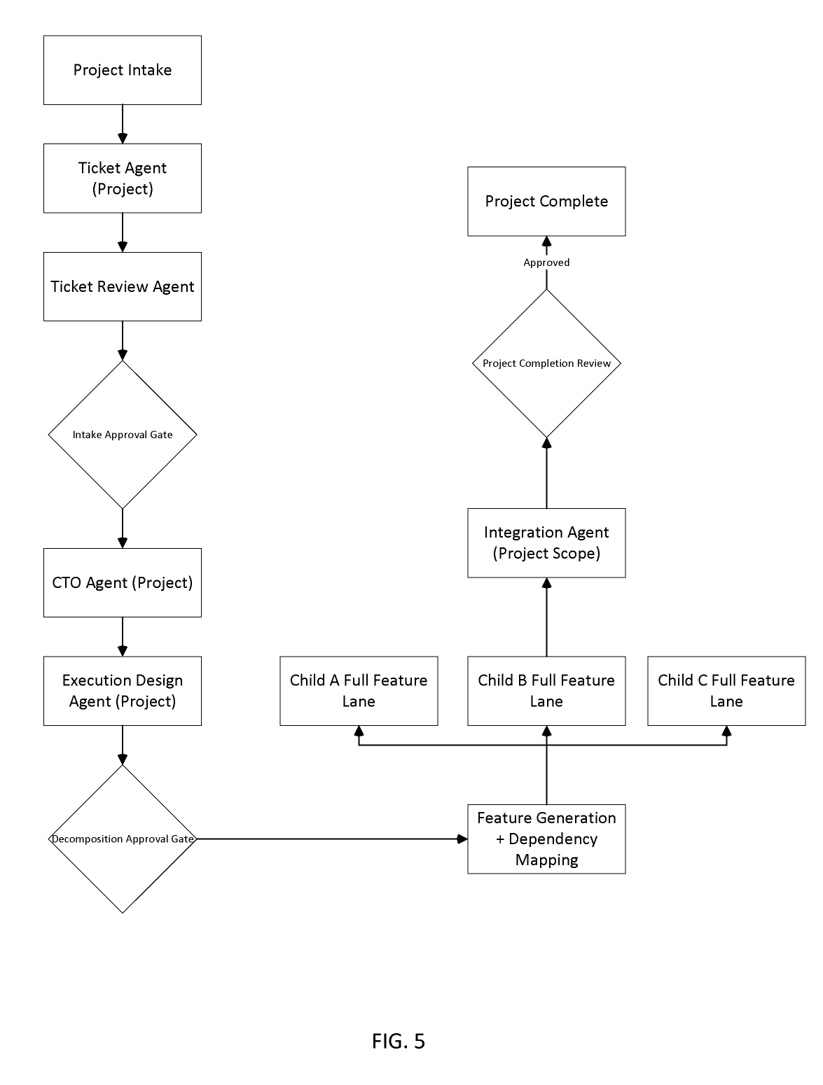

Referring now to FIG. 5, the Project/Epic Lane 506 handles multi-feature initiatives. A critical architectural invariant enforced by the Invariant Enforcement Layer 114 is that the Project Lane 506 never enters the READY_FOR_CODING or IN_PROGRESS states—it never codes directly. Instead, the CTO Agent 208 Project Variant defines the decomposition model and architectural constraints, the Execution Design Agent 210 Project Variant translates this into executable feature units with sequencing and dependency ordering, and after a required human Decomposition Approval Gate 606, the orchestrator generates child features that each execute independently through the complete Feature Lane 502. Each child feature inherits all Feature Lane gates (Intake Approval 602, Pre-Coding Approval 604, Pre-Merge Approval 608). After all child features complete, the Integration Agent 302 operates in Project Scope mode to perform cross-feature recomposition validation, and a final required Project Completion Review Gate 610 provides human governance over the completed initiative.

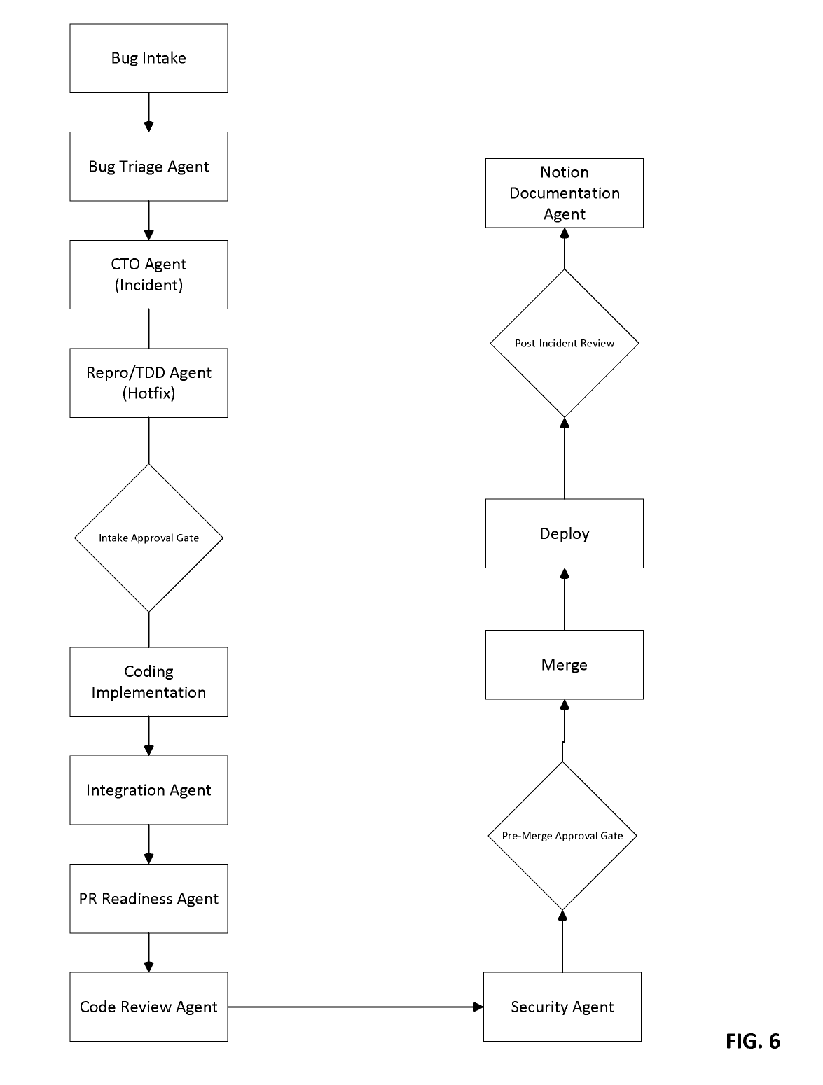

Referring now to FIG. 6, the Hotfix/Incident Lane 508 is optimized for production incident response. The Bug Triage Agent 206 classifies the issue as a hotfix candidate when: the issue affects production or near-production critical operations, impact justifies expedited remediation, and waiting for the normal Bug Lane 504 creates unacceptable risk. The CTO Agent 208 Incident Variant replaces both the standard CTO Bug Variant and the Execution Design Agent 210, defining the smallest safe fix, strict do-not-touch zones, and an actionable rollback strategy. The Execution Design Agent 210 is architecturally prohibited in this lane per the Invariant Enforcement Layer 114. The Repro/TDD Agent 214 Hotfix Variant defines minimum-viable reproduction and regression coverage. The Pre-Coding Approval Gate 604 may be deferred to maintain incident response speed. The Refactor Agent 304 612 312. The Post-Incident Review Gate 612 is a human-owned governance gate requiring a structured review record before documentation may proceed.

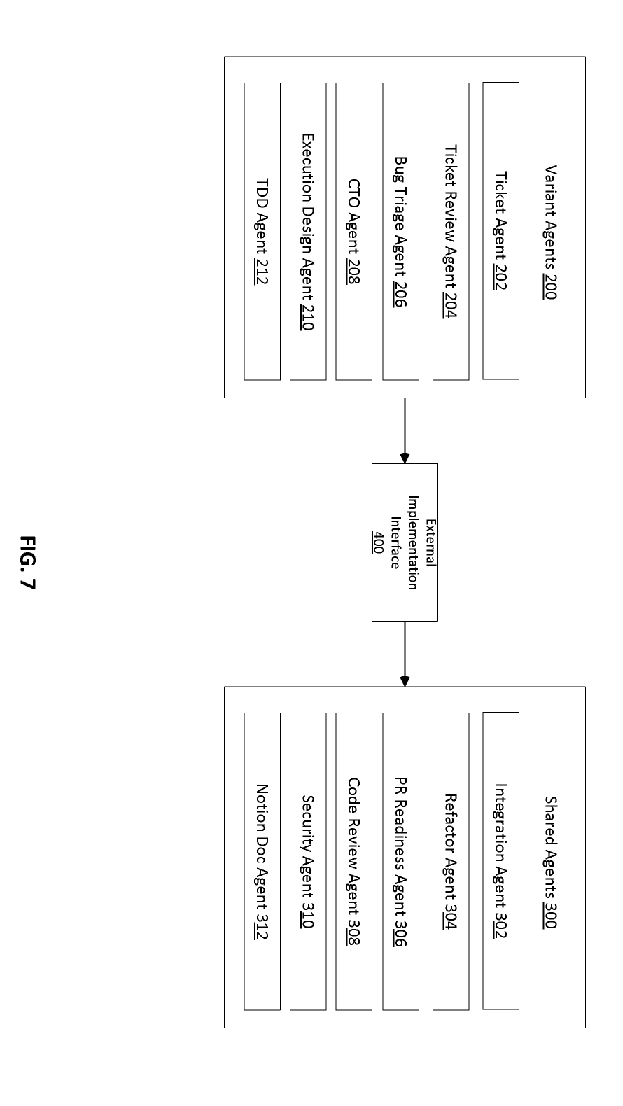

Referring now to FIG. 7, the agent architecture is divided into two zones with a clear architectural boundary. The Variant Agent Zone 200 contains all agents that exhibit lane-specific behavioral variation. These agents are specialized to the planning requirements of each work type: the Ticket Agent 202 has Standard and Project variants; the CTO Agent 208 has Feature, Bug, Project, and Incident variants; the Execution Design Agent 210 has Feature, Bug Fix, and Project variants; and the TDD/Repro-TDD Agent family (212/214) has Feature, Bug, and Hotfix variants. Variant selection is controlled by the Orchestrator Decision Engine 104 at invocation time based on work classification.

The Shared Agent Zone 300 contains all agents that must maintain identical behavior regardless of the originating workflow lane. The Integration Agent 302, Refactor Agent 304, PR Readiness Agent 306, Code Review Agent 308, Security Agent 310, and Notion Documentation Agent 312 apply uniform quality, security, and review standards to all work. This architectural constraint is enforced by the Invariant Enforcement Layer 114, which asserts that shared-zone agents must not exhibit lane-specific behavioral divergence. Variants shape the inputs to shared agents (through upstream constraints, scope boundaries, and approved patterns) but do not change how shared agents evaluate, review, or validate code.

Referring now to FIG. 6, the Hotfix/Incident Lane 508 is optimized for production incident response. The Bug Triage Agent 206 classifies the issue as a hotfix candidate when: the issue affects production or near-production critical operations, impact justifies expedited remediation, and waiting for the normal Bug Lane 504 creates unacceptable risk. The CTO Agent 208 Incident Variant replaces both the standard CTO Bug Variant and the Execution Design Agent 210, defining the smallest safe fix, strict do-not-touch zones, and an actionable rollback strategy. The Execution Design Agent 210 is architecturally prohibited in this lane per the Invariant Enforcement Layer 114. The Repro/TDD Agent 214 Hotfix Variant defines minimum-viable reproduction and regression coverage. The Pre-Coding Approval Gate 604 may be deferred to maintain incident response speed. The Refactor Agent 304 612 312. The Post-Incident Review Gate 612 is a human-owned governance gate requiring a structured review record before documentation may proceed.

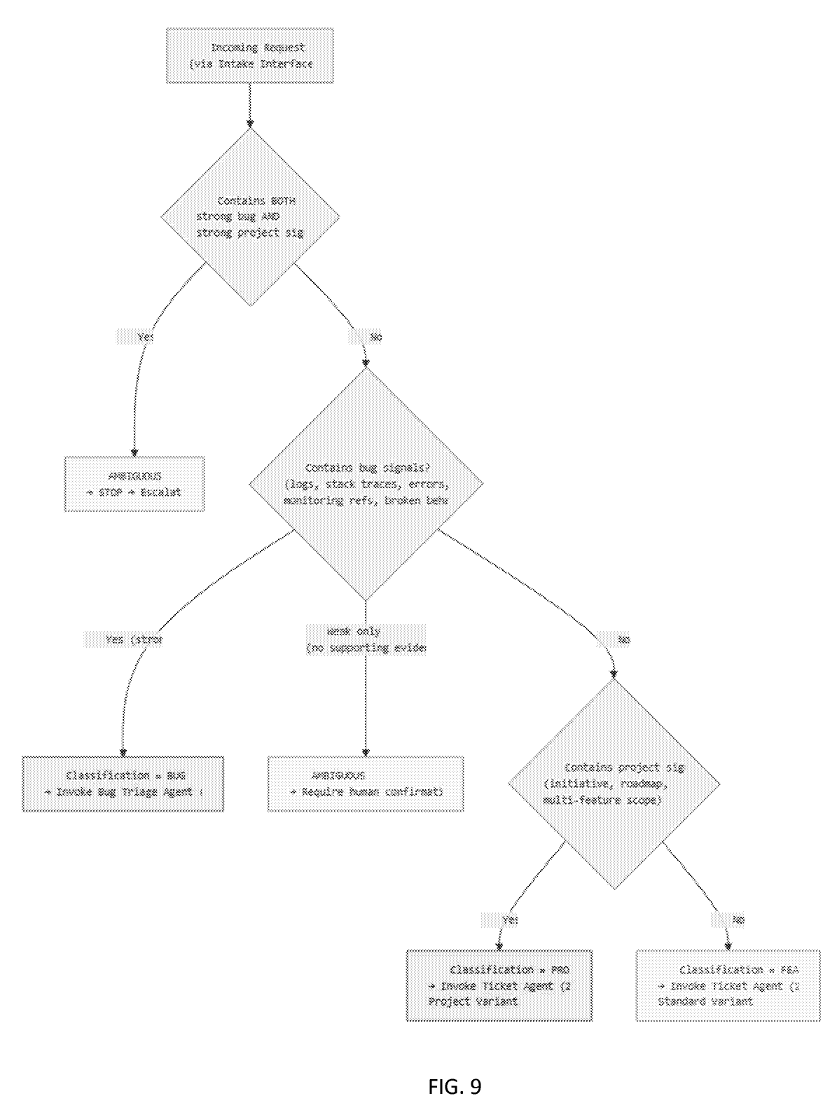

Referring now to FIG. 9, the Intake Classification Engine 106 applies a deterministic decision tree to classify each incoming work request. The first evaluation checks for conflicting signals—if the input matches both strong bug indicators and strong project indicators simultaneously, the classification is set to AMBIGUOUS and processing is halted for human resolution. If no conflict exists, the engine checks for bug-specific indicators: the presence of logs, stack traces, error messages, monitoring system references, or explicit broken-behavior language. Strong matches produce a BUG classification routing to the Bug Triage Agent 206; weak matches lacking supporting evidence produce an AMBIGUOUS classification requiring human confirmation. In the absence of bug signals, the engine checks for project signals including initiative language, roadmap references, and multi-feature scope, producing a PROJECT classification routing to the Ticket Agent 202 Project Variant. All remaining inputs default to a FEATURE classification routing to the Ticket Agent 202 Standard Variant.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as the computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

In one aspect, a method may include an operation, an instruction, and/or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112(f) unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method for automated software development lifecycle integrating specialized multi-agent frameworks arranged in a deterministic, multi-lane processing architecture.
